(19) United States
(12) Patent Application Publication
(10) Pub. No.: US 2008/0218664 A1
(43) Pub. Date: Sep. 11, 2008

(54) FLUORESCENT LAMP AND IMAGING DEVICE USIGN THE SAME

(76) Inventors: Shin IMAMURA, Kokubunji (JP); Kenji Okishiro, Kawasaki (JP); Masaki Nishikawa, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/033,907

(22) Filed: Feb. 20, 2008

(30) Foreign Application Priority Data
Mar. 8, 2007 (JP) 2007-058911

(51) Int. Cl. H01J 1/62; G02F 1/1335

(52) U.S. Cl. 349/71; 313/486

(57) ABSTRACT

In conventional fluorescent lamps and imaging devices using the same, there have been challenges that lighting efficiency should be enhanced and variation in emission colors should be reduced. The present invention has solved these challenges by providing a novel fluorescent lamp. The phosphor layers of the fluorescent lamp is composed of at least two types of phosphors, in which at least the most outer surface is a phosphor layer made of one of the phosphors (the first phosphor); and the rest portion of the phosphor layers, is made of mixed phosphors including a plurality of phosphors having respective emitting colors.

### CLAIM OF PRIORITY

The present application claims priority from Japanese application JP 2007-058911 filed on Mar. 8, 2007, the content of which is hereby incorporated by reference into this application.

### FIELD OF THE INVENTION

The present invention relates to a phosphor layer with high resolution, long life, high brightness, and good color reproducibility, which is suitable for image display. The present invention also relates to an imaging device using the same, such as a liquid crystal display.

### BACKGROUND OF THE INVENTION

An imaging device in the present invention means a device in which a phosphor is excited by being given energy to emit a light, resulting in displaying image information. Examples of such imaging devices include a non-self-luminous imaging device which is provided with a light source as a back light or side light, in a non-self-luminous display portion, such as a liquid crystal display panel. The above examples also include a whole system for displaying images in which the liquid crystal display panel and the light source mentioned above, are implemented as a display unit, and a driving unit and an image processing circuit or the like are additionally incorporated so as to display images.

Of an imaging device, a liquid crystal display device will be mainly explained hereinafter. In a liquid crystal display device, color display is performed in a way in which a light emitted from a light source 5 is guided to the side of a liquid crystal display panel by a back light unit, then the light is adjusted in its transmission quantity for each pixel, and one of red color, green color, or blue color is transmitted through after the light is separated, for each pixel in a liquid crystal display panel 2.

In general, a cold cathode fluorescent lamp (CCFL) is used for a light source of a liquid crystal display device. FIG. 5 shows a cross sectional view along the major axis of a CCFL. The CCFL has a structure in which a phosphor 12 is coated on the inner wall of a glass tube 11 and electrodes 13 is provided on the either side of the glass tube. In addition, mercury Hg and rare gas (argon Ar or neon Ne) are enclosed as discharge mediums 14 in the tube.

A CCFL used for a back light (the same meaning as a light source) of this type has a very long, narrow and characteristic shape, unlike a fluorescent lamp for interior illumination. In general, a fluorescent lamp for interior illumination has a diameter of tube (inner diameter of tube) of about 30 mm and a length of tube of about 1100 mm. On the other hand, a CCFL has, for example, in the case of a 32-inch liquid crystal display device, a diameter of tube (inner diameter of tube) of about 4 mm and a length of tube of about 720 mm. A CCFL is characterized in that its diameter of tube is very small.

Such a CCFL is lighted by applying a high voltage between the electrodes 13 of both ends. Electrons emitted from the electrode by applying a voltage, excite mercury Hg, resulting in radiation of an ultraviolet light when the excited mercury Hg returns to a ground state. A phosphor is excited by the ultraviolet light to emit a visible ray to the outside of a tube.

A phosphor 12 provided in a CCFL is made by mixing three powders to the extent in which the mixture has a predetermined white chromaticity, the three powders are: a blue phosphor of which luminescent color is blue (main luminescence peak wavelength falls in a range of about 400 nm to about 500 nm); a green phosphor of which luminescent color is green (main luminescence peak wavelength falls in a range of about 500 nm to about 600 nm); and, a red phosphor of which luminescent color is red (main luminescence peak wavelength falls in a range of about 600 nm to about 650 nm).

As phosphors for these three colors, blue phosphor BaMgAl₁₀O₁₇:Eu²⁺, green phosphor LaPO₄: Tb³⁺, Ce³⁺, and red phosphor Y₂O₃:Eu³⁺ are generally used. Alternatively, (Ba, Ca, Mg, Sr)₁₀(PO₄)₆Cl₂:Eu²⁺ (generally referred to as an SCA phosphor) is sometimes used as a blue phosphor; BaMgAl₁₀O₁₇:Eu²⁺, Mn²⁺ is as a green phosphor; and YVO₄:Eu³⁺ is as a red phosphor.

As a usual notational system of phosphor materials, the front part before “:” shows a host material composition, and the rear part thereafter shows a luminescence center, meaning that part of atoms of the host material is substituted in the luminescence center. For example, in the case of green phosphor LaPO₄:Tb³⁺, Ce³⁺, LaPO₄ is a host material and part of lanthanum La is substituted by terbium Tb which is a luminescence center. In addition, Cerium Ce is added thereto as a sensitizer which sensitizes luminescence of Tb. Hence, LaPO₄:Tb³⁺, Ce³⁺ may be described as (La, Tb, Ce)PO₄ as well.

As shown in FIG. 4A, the visible ray emitted from the CCFL (light source 5) enters a liquid crystal display panel 2 opposed to the back light unit 1, after transmitting through optical members disposed directly above the CCFL, the optical members including a diffuser plate 6, a prism sheet 7, and a reflective polarizer 8 or the like. In order to enhance the efficiency in utilizing the light from the CCFL, a reflector 4 is disposed directly under the CCFL, and the light reflected by the reflector also enters the liquid crystal display panel 2, after transmitting through the aforementioned optical members.

On the other hand, the liquid crystal display panel 2 has a cross-sectional structure shown in FIG. 9. That is, the structure includes: a pair of glass substrates 21 (21A, 21B) which are opposed to each other; two alignment layers 23 coated respectively on the inner surfaces of the glass substrates; and liquid crystal 24 and color filters 25 (red color 25A, green color 25B, blue color 25C) which are both sandwiched between the glass substrates.

A distance between the glass substrates 21 (21A-21B) is maintained by a spacer 26. Polarizers 22 (22A, 22B) are disposed on the outside of the pair of substrates 21 (21A, 21B), respectively. Liquid crystal 24 is uniformly oriented by the alignment layer 23, and driven by applying a voltage to a group of electrodes formed for each pixel (not shown in FIG. 9). When applying a voltage, liquid crystal rotates according to an electric field occurred by the voltage, which alters a refractive index of the liquid crystal layer, resulting in adjustment of a transmission quantity of light.

Color filters 25 (25A, 25B, 25C) separate the white light W emitted from the back light unit 1, into red light R, green light G, and blue light B, for each pixel, and transmits one of the three lights. A liquid crystal display device performs color display in this way where a light emitted from a light source provided in a back light unit is adjusted in transmission quantity thereof by a liquid crystal display panel, for each pixel, and separates the light with a color filter which transmits one of lights of red, green and blue, for each pixel.

As a literature regarding the structure of a phosphor layer coated on a lamp to improve the property of a fluorescent lamp used for a white light source mentioned above, JP-A No. 2002-56815 can be cited. However, according to the embodiments disclosed in the literature, brightness of a fluorescent lamp has not been sufficiently enhanced.

### SUMMARY OF THE INVENTION

In recent years, liquid crystal display devices have been widely used mainly in the market of large-sized liquid crystal TV receivers, and lower cost and higher image quality have been demanded. In order to satisfy these demands, higher brightness and reduction in variation in chromaticity of a CCFL, a light source, should be achieved.

Especially, higher brightness of a CCFL is an important issue, and if the issue is solved, liquid crystal display devices can be produced at a lower cost. For example, when designing a back light unit having the same luminance as with a conventional unit, it becomes possible to reduce the number of CCFLs than that of the conventional one, and further considering that the number of converters can also be reduced at a time, a back light unit can be produced at a greatly lower cost. Furthermore, a CCFL with higher brightness can omit some of the optical members (for example, luminance improving film etc.) that intervene between the CCFL and a liquid crystal display panel, which enables a liquid crystal display device to be produced at a lower cost.

On the other hand, variation in chromaticity of a CCFL is a factor which greatly affects the image quality of a liquid crystal display device, therefore reduction of the variation is an important issue. In a liquid crystal display device, a human being looks directly at a light source through a liquid crystal display panel, because the display device adjusts the transmission quantity of a light emitted from a light source with the liquid crystal display panel, and displays images by separating the light. Therefore, the chromaticity property of a CCFL directly affects the color tone of a liquid crystal display device.

Accordingly, the present invention will solve these issues that luminance of a light source represented by a CCFL should be enhanced and variation in chromaticity should be reduced, with a means described below, in order to enable a liquid crystal display device which is growing larger and larger to be produced at a lower cost, and to be capable of offering higher image quality, at a same time.

The present invention is intended to solve the issues that luminance of a light source should be enhanced and variation in chromaticity should be reduced, and to provide an imaging device with higher brightness and capability of offering higher image quality, with the use of the following means.

The above purpose can be achieved by a fluorescent lamp and an imaging device using the same, in which the fluorescent lamp is produced in the following way: in a fluorescent lamp having a structure in which a phosphor layer made by laminating phosphor particles is provided, and a primary light is generated by discharge to excite the phosphor layer, resulting in generating a secondary light; the phosphor layer is composed of at least two types of phosphors, and at least the most outer surface layer on the side of emitting the secondary light, along the thickness direction of the phosphor layer, is a phosphor layer of one of the phosphors (the first phosphor); and the rest portion of the phosphor layers except, is a layer of the mixed phosphors including plural phosphors having respective emitting colors.

Furthermore, as another structure of the present invention, the above purpose can also be achieved by a fluorescent lamp and an imaging device using the same: in which the fluorescent lamp is produced in the following way: in a fluorescent lamp having a structure in which a phosphor layer made by laminating phosphor particles is provided, the phosphor layer being invented in the present invention, and a primary light is generated by discharge to excite the phosphor layer, resulting in generating a secondary light; the phosphor layer is composed of at least two types of phosphors, and when assuming a weight ratio of one of a phosphor (the first phosphor) to the entire phosphors of the entire layer is x, and another weight ratio of the first phosphor to the phosphors included in the most outer surface layer on the side of emitting the secondary light, is y, y falls in the range of 0≦x≦y<1.

Furthermore, the present invention described above can be remarkable in its advantages by setting the phosphor with the first luminescent color to be any one of single color luminescence phosphors of red, green, or blue.

Still furthermore, the present invention described above can be remarkable in its advantages by setting the median diameter d50 of the phosphor with the first luminescent color to be 3.0 μm or less.

Still furthermore, the present invention described above can be remarkable in its advantages by completely covering the inner surface of the lamp with the phosphor layer, in the above fluorescent lamp.

Still furthermore, the present invention described above can be remarkable in its advantages by setting the fluorescent lamp to be a white emitting fluorescent lamp with a cold cathode structure having a phosphor layer containing a red emitting phosphor, a green emitting phosphor, and a blue emitting phosphor, in the above fluorescent lamp.

Still furthermore, the present invention described above can be remarkable in its advantages by setting the median diameter d50 of the phosphors used in the above fluorescent lamp except the first phosphor, to fall in the range of 1.0 μm to 10.0 μm.

The principle on which these means cause luminance to be enhanced and variation in chromaticity to be reduced, will be described below. As a result of examination of phosphor layers for lamps, it has been found that an ultraviolet light which excites a phosphor is not entirely utilized and part of the ultraviolet light transmits through a phosphor layer, thus there being an ultraviolet light which is not utilized. If an ultraviolet light is utilized more efficiently, it can be possible to enhance the luminance of a fluorescent lamp.

Thus, it has been examined what amount of ultraviolet light is utilized in four phosphor layers made of: red single color phosphor, blue single color phosphor, green single color phosphor, and white color phosphor which is made by mixing the above three color phosphors. As a result, it has been found that a single color phosphor layer can enhance the rate in which an ultraviolet light is utilized, by adjusting the powder property. As opposed to that, a mixed white color layer has been found that it is difficult to enhance the quality of the layer, because each phosphor used differs from each other in its particle diameter, particle shape, and specific gravity or the like, leading to the fact that less amount of ultraviolet light is utilized than a single color layer.

From this result, it has been found that a phosphor layer structure which has partially a layer of a single color layer can utilize ultraviolet light more efficiently than another layer structure in which the whole phosphor layer is composed of mixed colors of red, blue, and green. Namely, the former can enhance luminance of a fluorescent lamp more greatly than the latter. On the other hand, a fluorescent lamp may be sometimes costly to form a complete single color layer on the inner wall of the lamp, because the shape of a lamp is long and narrow. As a result of examination of how easy a phosphor layer can be formed, an ultraviolet light has been utilized efficiently even in the case where phosphors are mixed. That is, when there is a layer having a higher weight ratio of one type of phosphor, the layer structure can utilize an ultraviolet light efficiently, similarly to the layer structure mentioned above. In addition, these advantages become remarkable when particle size and the layer shape of a phosphor satisfy the above specific requirements.

In a layer mixed with three colors, a content ratio among the three colors, which was simply calculated when forming a layer, generally differs from a luminescence ratio among the three colors. A luminescence ratio of the three colors also differs depending upon layer forming conditions. It is difficult to adjust color because a change of an amount of a color affects other two colors. These factors cause variation in chromaticity of a fluorescent lamp, and the variation cannot be reduced easily in layer structures at present.

In the present invention, a layer composed of one single color is an independent layer, therefore the layer structure is less likely to be affected by layer forming conditions, unlike a mixed layer. In addition, color can be easily adjusted because the color can be independently altered in its amount of use. With such things, a layer structure according to an aspect of the present invention shows less variation in chromaticity of a fluorescent lamp.

Advantages of the present invention are effective without being limited to the shape or excitation method of a fluorescent lamp, because it is based on the above principles. The above CCFL lamp is only an example, and advantages of the present invention are also effective in the case of other lamps, for example, a fluorescent lamp with a flat shape, a hot cathode fluorescent lamp (HCFL), or a fluorescent lamp using an ultraviolet light generated by Xe discharge, as an excitation source.

Furthermore, advantages of the present invention are effective without being limited to the type of a phosphor. The above phosphor is only an example, and advantages of the present invention are also effective in the case where another type of a phosphor is used. A conventional fluorescent lamp is coated on its inner surface of the tube with fine particles of Y₂O₃ which do not emit light, as a protective layer of a phosphor. The present invention has an advantage that the fine particles of Y₂O₃can be omitted with the use of a single layer of a phosphor. Conversely, a method for forming a single layer of a phosphor on inner surface of a fluorescent lamp according to an aspect of the present invention can enhance luminance and reduce variation in chromaticity without an additional manufacturing cost in comparison with a conventional fluorescent lamp, when conventionally-used Y₂O₃ which does not emit light is omitted.

In the present invention, enhancement of luminance and reduction of variation in chromaticity in a light source can be satisfied at a same time, with the use of the above means. Furthermore, an imaging device capable of offering high image quality can be obtained by using such a light source.

### BRIEF DESCRIPTION OF THE DRAWINGS

FIG. 1 is a diagram showing a structure of a layer of a phosphor according to an aspect of the present invention;

FIG. 2 is a graph comparing luminance property of the present invention to that of the conventional phosphor;

FIG. 3 is a graph showing the property of the relative luminance of the green phosphor;

FIG. 4 is a diagram showing an exploded perspective view of a liquid crystal display device;

FIG. 5 is a diagram showing an outline of a cross-sectional structure of a CCFL;

FIG. 6 is a diagram showing an outline of a cross-sectional structure of a HCFL;

FIG. 7 is a diagram showing a schematic cross-sectional structure of an EEFL;

FIG. 8 is a diagram showing a schematic cross-section of a flat light source; and

FIG. 9 is a diagram showing a schematic cross-sectional structure of a liquid crystal display panel.

### DETAILED DESCRIPTION OF THE PREFERRED EMBODIMENTS

Preferred embodiments of the present invention will be described in detail below with reference to the accompanying drawings.

### First Embodiment

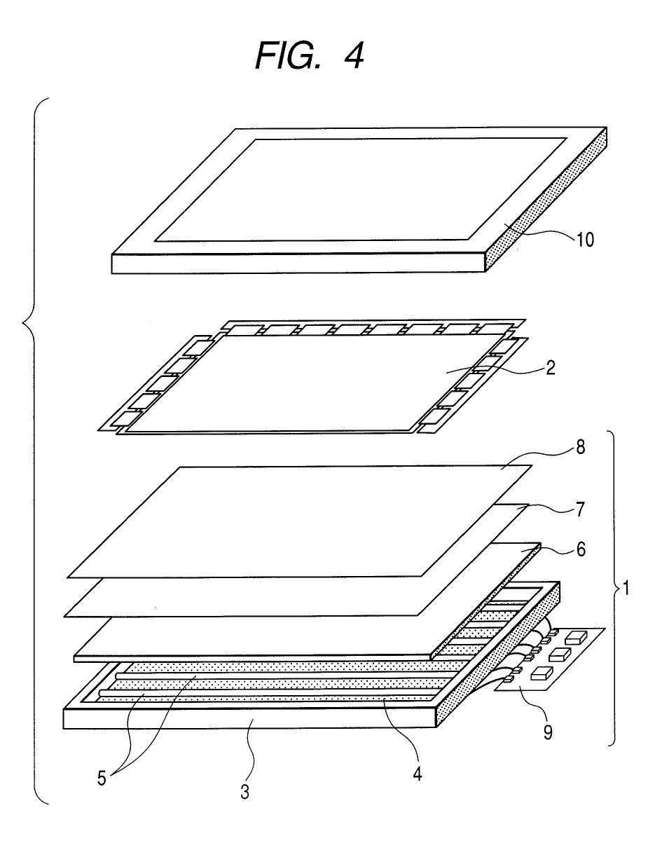

An imaging device having a structure according to an aspect of the present invention was produced by the following method, and the property thereof was evaluated. A liquid crystal display device in the present embodiments is composed of a back light unit 1 and a liquid crystal display panel 2, as shown in FIG. 4. The back light unit 1 includes a white light source 5, a drive circuit 9 (inverter) for lighting the light source, a frame 3, a reflector 4, a diffuser plate 6, a prism sheet 7, and a reflective polarizer 8. The above back light unit is an example; therefore, the unit need not include all of the component parts mentioned above, or may add another part. In short, a back light unit means what illuminates the liquid crystal display panel 2 in order to form images.

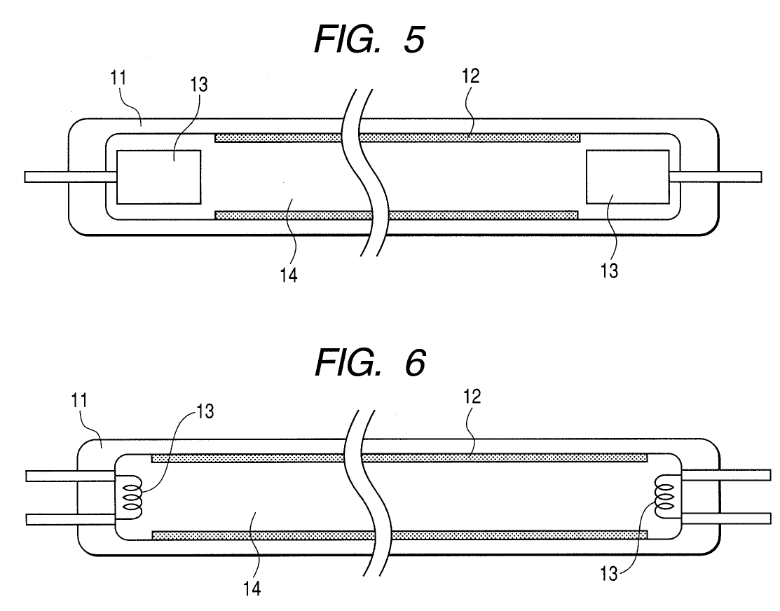

In the present embodiments, a CCFL shown in FIG. 5 was used as a white light source. At the time, a CCFL using a phosphor layer which was mixed with a red phosphor, green phosphor, and blue phosphor was produced as a conventional phosphor. As the first embodiment according to the invention, a CCFL was produced in a way in which a phosphor layer of a green phosphor was produced as an independent layer, which was added to a phosphor layer mixed with red, green, and blue phosphors. How to produce a CCFL and an IPS mode liquid crystal display device using the CCFL will be described below.

The production procedures of the CCFL are shown below. At first, adhesive materials, such as alumina, and phosphor materials of each color are mixed into an organic solvent composed of nitrocellulose called a vehicle, and butyl acetate. The mixed liquid is called a suspension. In order to form a conventional phosphor, a suspension was employed, in which a blue phosphor BaMgAl₁₀O₁₇:Eu²⁺, green phosphor LaPO₄:Tb³⁺, Ce³⁺, and red phosphor Y₂O₃:Eu³⁺ were mixed as a phosphor. In order to form the first embodiment of the invention, a suspension using a green phosphor LaPO₄:Tb³⁺, Ce³⁺ was produced. The median diameters d50 of particles of these all phosphors were in the range of 1.0 μm to 10.0 μm. The median diameters of d50 were measured by a “Coulter Counter” (Beckman Coulter, Inc.).

Next, one side of a glass tube washed beforehand was dipped in this suspension, and pulling up the suspension up to the other side of the glass tube by sucking the suspension with a pump, resulted in coating the inner wall of the glass tube with a phosphor. In a conventional phosphor, a layer of phosphor was formed using suspension mixed with three color phosphors. In the first embodiment, two layers of phosphors were formed: one layer was formed by using a single suspension of green phosphor; and the other layer by using a suspension mixed with three color phosphors.

The glass tube is made of Koval glass, and has its diameter of 3 mm. The phosphor was adhered to the inner wall of a glass by baking the glass tube. An electrode was then attached thereto and one side of the glass tube is sealed. Gas pressure in the glass tube was adjusted by pouring rare gas, such as argon Ar and neon Ne, and exhausting the gas, from the opposite side of the sealed side. After pouring mercury additionally, the glass tube was sealed. Finally, aging processing was performed by lighting the glass tube for a certain period of time.

Assembly of a back light unit will be explained later with reference to FIG. 4. Plural CCFLs 5 produced in the above way were disposed on a metal frame 3. In liquid crystal display devices which are required for higher luminance, such as liquid crystal TV receivers, the direct under-light system is employed, in which plural CCFLs are disposed planarly side by side.

A reflector 4, which is used for efficiently utilizing the light emitted from the CCFLs 5 toward a metal frame 3, was disposed between the metal frame 3 and the CCFLs 5. In addition, a diffuser plate 6 was disposed directly above the CCFLs to curb the in-plane distribution of luminance in a liquid crystal display device. A prism sheet 7 and a reflective polarizer 8 were additionally disposed to enhance luminance of a liquid crystal display device. An inverter 9 was connected to the CCFL so that control of lighting of the CCFL was performed by driving of the inverter. These parts are collectively called the back light unit 1.

A liquid crystal display panel 2 was disposed directly above the back light unit 1, in which the liquid crystal display panel had a color filter which adjusted transmission quantity of light from the back light (white light source CCFL), and which separated the light into red light, green light, and blue light, for each pixel.

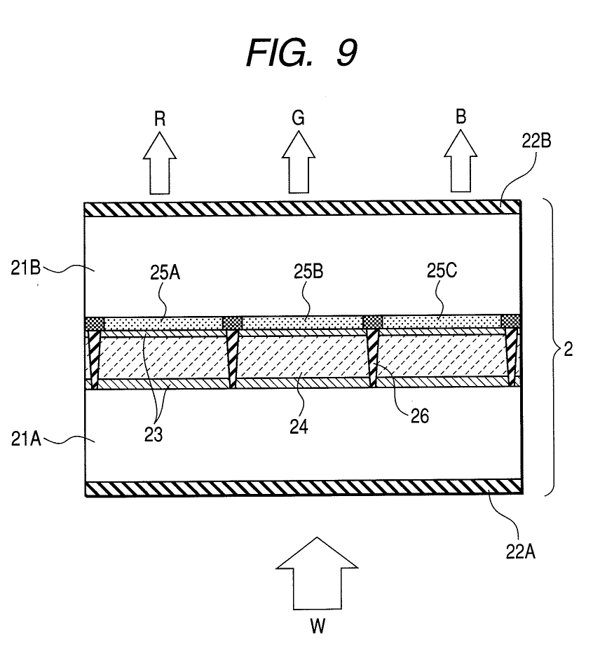

A cross-sectional schematic diagram of the liquid crystal display panel is as shown in FIG. 9. A 0.5 mm thick glass substrate is typically used for a substrate 21. On a substrate 21A of one side, an electrode (not shown in FIG. 9) was formed for each pixel, and a thin film transistor (TFT), which supplied a voltage to these electrodes, was formed. On a substrate 21B of the other side, color filters 25 (red 25A, green 25B, blue 25C) were formed for each pixel. Alignment layers 23 were formed on the surfaces of the pair of substrates to make the liquid crystal molecule align; further the liquid crystal 24 was sandwiched between the substrates. In addition, polarizers 22 (22A, 22B) were disposed outside the substrates. Finally, the combination of the back light unit 1 and the liquid crystal display panel 2 was covered with a frame 10, resulting in a liquid crystal display device.

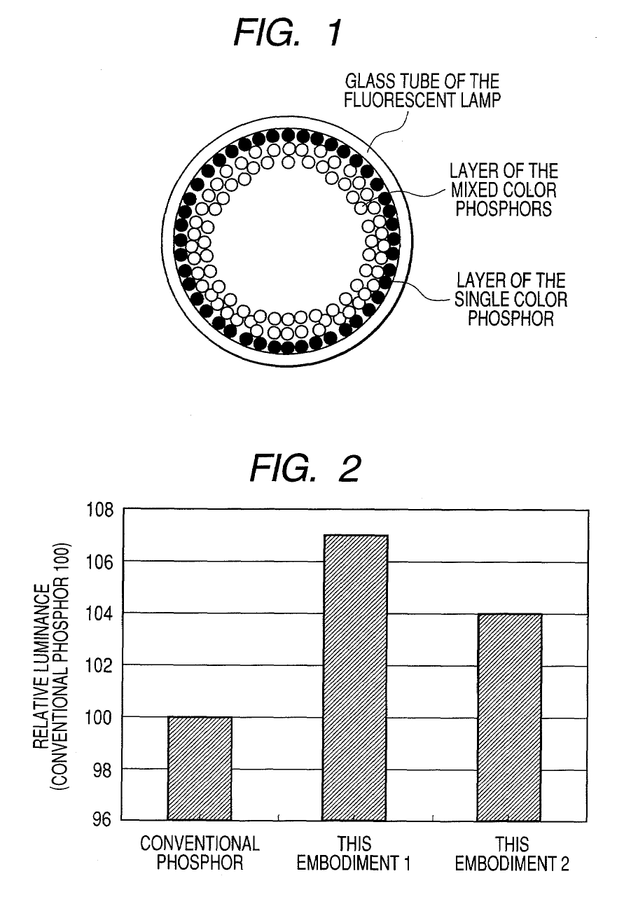

According to the first embodiment, a layer structure of the present invention, which is shown in FIG. 1, was produced. In this case, a layer of the single color phosphor of FIG. 1 is made of a green phosphor. White luminance was measured in the conventional phosphor and the second embodiment, and the result is shown in FIG. 2, in which values of the second embodiment show relative luminance against values of the conventional phosphor which are 100. A white color temperature in FIG. 2 is 7000K. It can be understood that luminance in the first embodiment is enhanced more than that in the conventional phosphor.

Furthermore, plural samples were produced so that chromaticity values of each liquid crystal display device were measured. As a result of measurements for red, green, blue, and white colors, the first embodiment had a less variation in chromaticity than the conventional phosphor. This chromaticity value can be obtained by measuring CIE xy coordinates. In phosphor layers of the first embodiment, a phosphor layer which covered a glass tube of the fluorescent lamp without a break had a higher luminance value than a phosphor layer which had a gap, such as a clearance and a hole, occurred due to a break. As described above, it can be possible that an ultraviolet light is utilized more efficiently, that is, an amount of ultraviolet light that transmitted through a phosphor layer to the outside of a fluorescent tube can be reduced, by forming a single layer of green color.

From the results, it has been proven that enhancement of luminance and reduction of variation in chromaticity in a CCFL, can be satisfied at a same time with the present invention. Therefore, a liquid crystal display device of high quality can be obtained with the use of such a light source, in which the liquid crystal display device can be produced at a lower cost, while being capable of offering high image quality.

### Second Embodiment

The second embodiment was produced in the same way as with the first embodiment. A difference between the second embodiment and the first embodiment is that in the second embodiment, two layers of phosphors were formed: one layer was formed by using a single suspension of a blue phosphor BaMgAl₁₀O₁₇:Eu²⁺; and the other layer by using a suspension mixed with three color phosphors.

Particles of these all phosphors used had diameters of which median diameters d50 were in the range of 1.0 μm to 10.0 μm. According to the second embodiment, a layer structure of the present invention, which is shown in FIG. 1, was produced. In this case, a layer of the single color phosphor of FIG. 1 is made of a blue phosphor.

White luminance was measured in the conventional phosphor and the second embodiment, and the result is shown in FIG. 2, in which values of the second embodiment show relative luminance against the values of the conventional phosphor which are 100. It can be understood that luminance in the second embodiment is more enhanced than that in the conventional phosphor. Furthermore, plural samples were produced so that chromaticity values of each liquid crystal display device were measured. As a result of measurements for red, green, blue, and white colors, the second embodiment had a less variation in chromaticity than the conventional phosphor.

In phosphor layers of the second embodiment, a phosphor layer which covered a glass tube of the fluorescent lamp without a break had a higher luminance value than a phosphor layer which had a gap, such as a clearance and a hole, occurred due to a break.

From the results, it has been proven that enhancement of luminance and reduction of variation in chromaticity in a CCFL, can be satisfied at a same time with the present invention. Therefore, a liquid crystal display device of high quality can be obtained with the use of such a light source, in which the liquid crystal display device can be produced at a lower cost, while being capable of offering high image quality.

### Third Embodiment

The third embodiment was produced in the same way as with the first embodiment. A difference between the third embodiment and the first embodiment is that in the third embodiment, two layers of phosphors were formed: one layer was formed by using a single suspension of red phosphor Y₂O₃: Eu³⁺; and the other layer by using a suspension mixed with three color phosphors.

At the time, a layer of the red single color phosphor was evaluated in the property thereof as median diameters d50 thereof were varied within the range of 0.05 μm to 10 μm, in which the median diameters d50 were measured by a “Coulter Counter” (Beckman Coulter, Inc.). Particles of all phosphors including red phosphors, which were used for forming the layer of the mixed color phosphors, had a constant and fixed value of median diameters d50 thereof, the median diameters d50 being in the range of 1.0 μm to 10 μm, in which the median diameters d50 were measured by a coal tar meter.

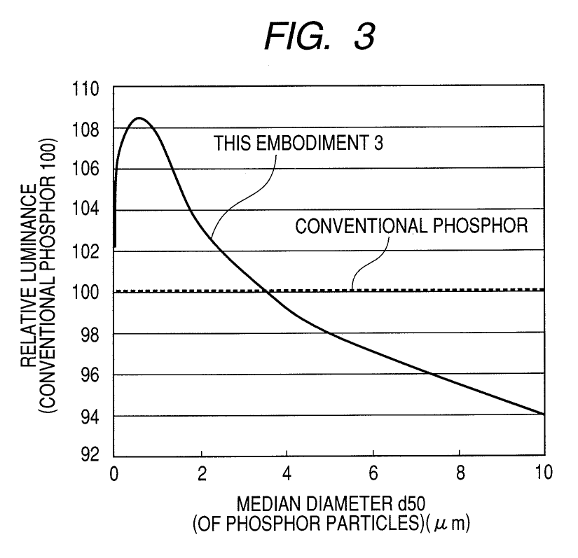

According to the third embodiment, a layer structure of the present invention, which is shown in FIG. 1, was produced. In this case, a layer of the single color phosphor of FIG. 1 is made of a red phosphor. White luminance was measured in the conventional phosphor and the third embodiment, and the result is shown in FIG. 3, in which values of the third embodiment show relative luminance against the values of the conventional phosphor which are 100. In the third embodiment, it can be understood that this embodiment using particles of which median diameters d50 are 3.0 μm or less, has a higher luminance than the conventional phosphor.

Furthermore, plural samples were produced so that chromaticity values of each liquid crystal display device were measured. As a result of measurements for red, green, blue, and white colors, the third embodiment had a less variation in chromaticity than the conventional phosphor. In phosphor layers of the third embodiment, a phosphor layer which covered a glass tube of the fluorescent lamp without a break had a higher luminance value than a phosphor layer which had a gap, such as a clearance and a hole, occurred due to a break. From the results, it has been proven that enhancement of luminance and reduction of variation in chromaticity in a CCFL, can be satisfied at a same time with the present invention. Therefore, a liquid crystal display device of high quality can be obtained with the use of such a light source, in which the liquid crystal display device can be produced at a lower cost, while being capable of offering high image quality.

In this embodiment, advantages thereof are described on condition that particles of the red phosphor as an independent layer, have the median diameters d50 thereof of 3.0 μm or less. It is clearly understood that the same advantages can be obtained when particles of the green phosphor used as an independent layer in the first embodiment and the blue phosphor used as an independent layer in the second embodiment, have the median diameters d50 thereof of 3.0 μm or less. However, a green phosphor and a blue phosphor have a feature that the same advantage as described above can be obtained even if particles thereof have the median diameters d50 thereof of more than 3.0 μm when being used as an independent layer.

### Fourth Embodiment

This example 4 differs from any one of these examples 1 to 3 in a type of a light source. While CCFLs were used in this embodiments 1 to 3, an HCFL (Hot Cathode Fluorescent Lamp) shown in FIG. 6 was used in this example. Phosphors used for the HCFL were the same as that of these embodiments 1 to 3.

While having a similar structure to that of a CCFL as shown in FIG. 6, the HCFL differs greatly from the CCFL in the fact that a metal electrode portion 13 of the HFCL is a filament electrode. When applying a voltage between two electrodes of the HCFL, thermal electrons are emitted from the filament to excite the mercury, resulting in emitting an ultraviolet light therefrom.

As a result of measuring white luminance of an HCFL using a phosphor layer of a conventional phosphor, and of the fourth embodiment, it has been found that this example 4 has a higher luminance than the conventional phosphor, in the same way as with this examples 1 to 3. Furthermore, plural samples were produced so that chromaticity values of each liquid crystal display device were measured. As a result of measurements for red, green, blue, and white colors, the fourth embodiment had a less variation in chromaticity than the conventional phosphor. In phosphor layers of the fourth embodiment, a phosphor layer which covered a glass tube of the fluorescent lamp without a break had a higher luminance value than a phosphor layer which had a gap, such as a clearance and a hole, occurred due to a break.

From the above results, it has been proven that enhancement of luminance and reduction of variation in chromaticity in a HCFL, can also be satisfied at a same time with the present invention. Therefore, a liquid crystal display device of high quality can be obtained with the use of such a light source, in which the liquid crystal display device can be produced at a lower cost, while being capable of offering high image quality.

### Fifth Embodiment

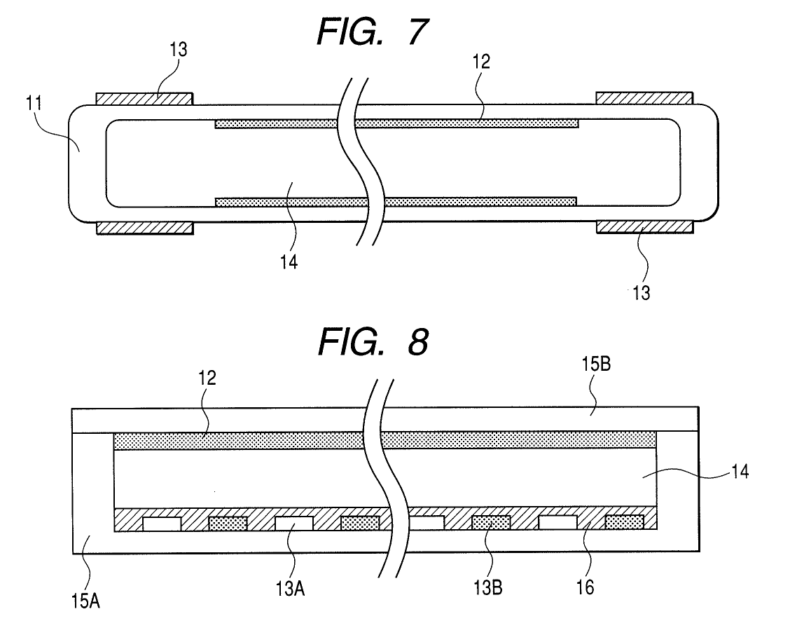

This example 5 differs from any one of these examples 1 to 3 in a type of a light source. While CCFLs were used in this embodiments 1 to 3, an EEFL (External Electrode Fluorescent Lamp) shown in FIG. 7 was used in this example. Phosphors used for the EEFL were the same as that of these embodiments 1 to 3.

The EEFL is produced in a different way from that of the CCFL with regard to forming an electrode portion. In the EEFL, after coating a phosphor on a glass tube, one side of the glass tube is sealed. After exhausting air from the other side of the tube, mercury which is a discharge medium is introduced within the tube, thereafter the other side of the tube being sealed. Then, a flexible electrode, for example, a copper tape, is disposed onto the outside of the glass tube.

In such EEFL, the glass tube itself serves as a capacitor, thereby a ballast capacitor not being required. Therefore, a multi-lighting system becomes possible in which plural lamps can be lighted with one inverter 9 at a time. This can reduce the number of inverters greatly compared with a CCFL, therefore an EEFL can be produced at a low cost.

As a result of measuring white luminance of an EEFL using a phosphor layer of a conventional phosphor, and of the fifth embodiment, it has been found that this example 5 has a higher luminance than the conventional phosphor, in the same way as with this examples 1 to 3. Furthermore, plural samples were produced so that chromaticity values of each liquid crystal display device were measured. As a result of measurements for red, green, blue, and white colors, the fifth embodiment had a less variation in chromaticity than the conventional phosphor. In phosphor layers of the fifth embodiment, a phosphor layer which covered a glass tube of the fluorescent lamp without a break had a higher luminance value than a phosphor layer which had a gap, such as a clearance and a hole, occurred due to a break.

From the above results, it has been proven that enhancement of luminance and reduction of variation in chromaticity in a HCFL, can also be satisfied at a same time with the present invention. Therefore, a liquid crystal display device of high quality can be obtained with the use of such a light source, in which the liquid crystal display device can be produced at a lower cost, while being capable of offering high image quality.

### Sixth Embodiment

This example 6 differs from any one of these examples 1 to 3 in a type of a light source. While a CCFL was used in these embodiments 1 to 3, a flat light source shown in FIG. 8 was used in this example. Phosphors used for the EEFL were the same as that of these embodiments 1 to 3.

A flat light source has a structure composed of a closed box 15 (rear glass 15A, front glass 15B) provided with a phosphor 12, and electrodes 13 (13A, 13B) disposed on the rear glass, as shown in FIG. 8. A layer of the single color phosphor was formed on the front glass 15B. A dielectric body 16 is disposed on the electrodes. A discharge medium 14 is enclosed within the closed box. Examples of light sources include a light source using Xe or mercury, while a discharge medium used varies depending on a type of a flat light source.

As a result of measuring white luminance of a flat light source using a phosphor layer of a conventional phosphor, and of the sixth embodiment, it has been found that this example 6 has a higher luminance than the conventional phosphor, in the same way as with this examples 1 to 3. Furthermore, plural samples were produced so that chromaticity values of each liquid crystal display device were measured. As a result of measurements for red, green, blue, and white colors, the sixth embodiment had a less variation in chromaticity than the conventional phosphor. In phosphor layers of the sixth embodiment, a phosphor layer which covered a glass tube of the fluorescent lamp without a break had a higher luminance value than a phosphor layer which had a gap, such as a clearance and a hole due to a break.

From the above results, it has been proven that enhancement of luminance and reduction of variation in chromaticity in a flat light source, can be satisfied at a same time with the present invention. Therefore, a liquid crystal display device of high quality can be obtained with the use of such a light source, in which the liquid crystal display device can be produced at a lower cost, while being capable of offering high image quality.

What is claimed is:

1. A fluorescent lamp which has a structure in which a phosphor layer made by laminating phosphor particles is provided, and a primary light is generated by discharge to excite the phosphor layer, resulting in generating a secondary light,
wherein the phosphor layer is composed of at least two types of phosphors; and at least the most outer surface layer on the side of emitting the secondary light, along the thickness direction of the phosphor layer, is a layer of a first one of the phosphor (the first phosphor); and the rest portion of the phosphor layers, is a layer of the mixed phosphors including a plurality of phosphors having respective emitting colors.

2. A fluorescent lamp which has a structure in which a phosphor layer made by laminating phosphor particles is provided, and a primary light is generated by discharge to excite the phosphor layer, resulting in generating a secondary light,
wherein the phosphor layer is composed of at least two types of phosphors; and when assuming a weight ratio of one of the phosphors (the first phosphor) to the entire phosphors of the entire layer is x, and a weight ratio of the first phosphor to the phosphors included in the most outer surface layer on the side of emitting the secondary light, is y, y falls in the range of 0≦x<y≦1.

3. The fluorescent lamp according to claim 1, wherein the first phosphor is any one of single color luminescence phosphors of red, green, or blue.

4. The fluorescent lamp according to claim 1, wherein the first phosphor is either one of single color luminescence phosphors of green or blue.

5. The fluorescent lamp according to claim 1, wherein a median diameter d50 of the first phosphor is 3.0 μm or less.

6. The fluorescent lamp according to claim 1, wherein a median diameter d50 of the first phosphor is smaller than a median diameter d50 of phosphors other than the first phosphor in the phosphor layer.

7. The fluorescent lamp according to claim 1, wherein the phosphor layer completely covers the inner surface of the fluorescent lamp.

8. The fluorescent lamp according to claim 1, wherein the fluorescent lamp is a cold cathode fluorescent lamp.

9. The fluorescent lamp according to claim 1, wherein the fluorescent lamp is a hot cathode fluorescent lamp.

10. The fluorescent lamp according to claim 1, wherein the fluorescent lamp is formed with a glass tube and the first fluorescence tube is in touch with the inner wall of the glass tube.

11. The fluorescent lamp according to claim 1, wherein a transmission rate of an ultraviolet light through the phosphor layer made of the first phosphor is smaller than a transmission rate of an ultraviolet light through the phosphor layer composed of at least two types of phosphors.

12. A liquid crystal display device including a back light unit which uses a fluorescent lamp for a liquid crystal display panel and a light source, the fluorescent lamp having a structure in which a phosphor layer made by laminating phosphor particles is provided, and a primary light is generated by discharge to excite the phosphor layer, resulting in generating a secondary light;
wherein the phosphor layer is composed of at least two types of phosphors; and at least the most outer surface layer on the side of emitting the secondary light, along the thickness direction of the phosphor layer, is a phosphor layer of a first emitting color; and the rest portion of the phosphor layers except the most outer surface layer, is a layer of the mixed color phosphors including a plurality of phosphors having respective emitting colors.

13. A liquid crystal display device including a back light unit which uses a fluorescent lamp for a liquid crystal display panel and a light source, the fluorescent lamp having a structure in which a phosphor layer made by laminating phosphor particles is provided, and a primary light is generated by discharge to excite the phosphor layer, resulting in generating a secondary light,
wherein the phosphor layer is composed of at least two types of phosphors; and when assuming a weight ratio of a first phosphor to the entire phosphors of the entire layer is x, and a weight ratio of the first phosphor to the phosphors included in the most the outer surface layer, from which the second light is emitted, is y, y falls in the range of 0≦x<y≦1.
